(19) United States
(12) Patent Application Publication
(10) Pub. No.: US 2010/0125724 A1
(43) Pub. Date: May 20, 2010

(54) COMPUTER DEVICE HAVING INITIALIZATION SETTING FUNCTION AND METHOD FOR MAKING INITIALIZATION SETTING FOR COMPUTER

(75) Inventor: MING-JUNG WU, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/615,751

(22) Filed: Nov. 10, 2009

(30) Foreign Application Priority Data
Nov. 17, 2008 (TW) 097144401

(51) Int. Cl. G06F 9/00

(52) U.S. Cl. 713/2

(57) ABSTRACT

A computer device having an initialization setting function and a method for making an initialization setting for a computer are provided. The computer device includes a BIOS, a button which generates a pressing frequency or a pressing time when it is pressed and a main body interface unit connected to the button or the BIOS to transmit signals. The main body interface unit generates a corresponding operation instruction according to the pressing frequency or the pressing time and makes the BIOS execute the operation instruction.

### FIELD OF THE INVENTION

The invention relates to a computer device having an initialization setting function and a method thereof and, more particularly, to a computer device making an initialization setting for a basic input/output system (BIOS) using a button and a method thereof.

### BACKGROUND OF THE INVENTION

A BIOS is the basic program loaded in a main body of a computer. The main function of the BIOS is to perform a power on self test (POST). That is, the BIOS examines whether a central processing unit (CPU) and other controllers are in normal state. The BIOS also may initialize a computer memory, a video card, a main board chipset and peripheral devices, provide the basic setting for various components and load the operation system. Therefore, the BIOS may be regarded as a micro operation system which specially communicates with the hardware. In addition, the BIOS also includes a diagnosing function to confirm that some important components such as a keyboard, a disc device, an input/output interface are initialized correctly and operated normally. Therefore, when the main body has problems, the BIOS should be checked first.

Before the general main body loads the operation system, a keyboard or a mouse should be connected as an input device through a universal serial bus (USB) interface or a personal system/2 (PS/2) interface to adjust the order of starting the equipment in the BIOS. However, in the following cases, the user may feel inconvenient.

When main bodies are used as servers, to facilitate the centralization management, a skilled person in the field does not usually connect a keyboard, a mouse and other peripheral devices to every main body. Therefore, if the main bodies have problems, and some basic setting of the BIOS should be checked or modified, keyboards are needed to be connected to the wrong main body s one by one. This is quite inconvenient for the user.

A home theater personal computer (HTPC) has the same problem. The HTPC is usually controlled by a remote controller. If the HTPC has problems, and the operation system cannot be entered, the remote controller which relies on the operation system also can not be used. At that moment, the keyboard is also needed to be connected to the HTPC to check the BIOS setting inside the HTPC to exclude the error.

### SUMMARY OF THE INVENTION

The objective of the invention is to provide a computer device having an initialization setting function and a method for making an initialization setting for a computer to improve the conventional technology.

The invention provides a computer device having an initialization setting function. The computer device includes a BIOS, a button which generates a pressing frequency or a pressing time when it is pressed and a main body interface unit connected to the button and the BIOS to transmit signals. The main body interface unit generates a corresponding operation instruction according to the pressing frequency or the pressing time and makes the BIOS execute the operation instruction.

The invention also provides a method for making an initialization setting for a computer. The method includes the steps as follows. A button is used to generate a pressing frequency or a pressing time. A corresponding operation instruction is generated according to the pressing frequency or the pressing time. The operation instruction is executed by the BIOS.

According to the computer device having the initialization setting function and the method for making an initialization setting for the computer provided in the invention, a button is additionally disposed at the front panel of the main body case. Thus, a user may press the button, and the pressing frequency or the pressing time is generated to make the BIOS execute the corresponding operation instruction.

### BRIEF DESCRIPTION OF THE DRAWINGS

These and other features, aspects and advantages of the present invention will become better understood with regard to the following description, appended claims, and accompanying drawings.

FIG. 1 is a functional block diagram showing the computer device having an initialization setting function provided in a preferable embodiment of the invention;

FIG. 2(a) is a schematic diagram showing the appearance of the computer device having an initialization setting function in a preferable embodiment of the invention;

FIG. 2(b) is a schematic diagram showing the appearance of the computer device having an initialization setting function in another preferable embodiment of the invention; and

FIG. 3 is a flow chart showing a processing method for making an initialization setting for a computer in a preferable embodiment of the invention.

### DETAILED DESCRIPTION OF THE PREFERRED EMBODIMENT

In the conventional technology, a main body of a computer has no independent input devices, and it needs a keyboard, a mouse or other external input devices. In the invention, a button is additionally disposed at the front panel of the main body case. Cooperating with a BIOS which may support the button input, the button is used to realize part of functions of the keyboard.

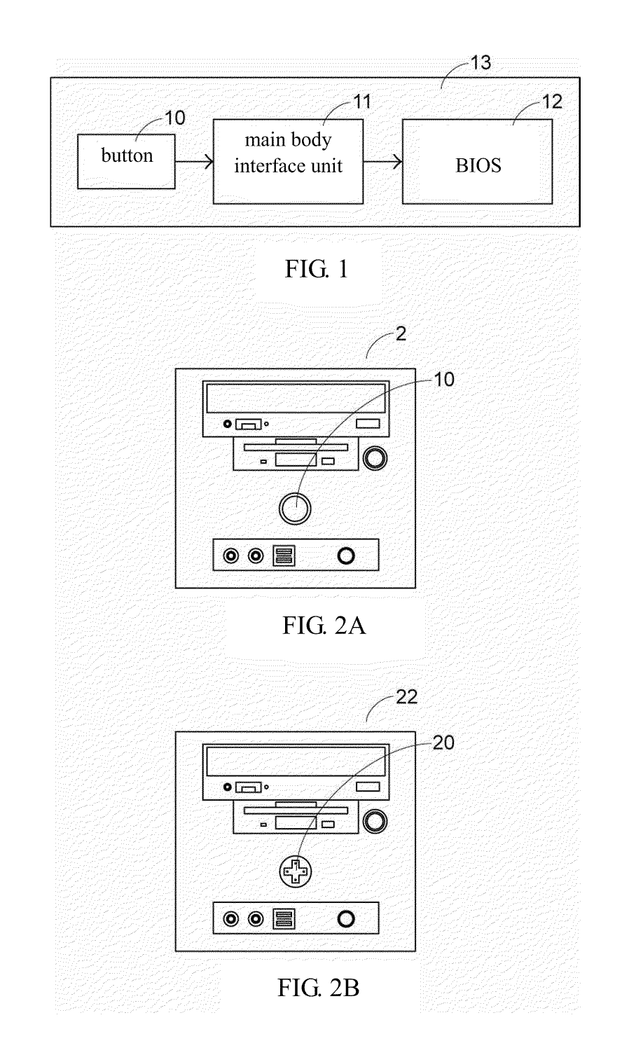

FIG. 1 is a functional block chart showing the computer device having an initialization setting function in a preferable embodiment of the invention. As shown in FIG. 1, the main body 13 includes a button 10, a BIOS 12 and a main body interface unit 11. The main body interface unit 11 is connected to the button 10 and the BIOS 12. The main body interface unit 11 may be achieved by an embedded controller, a general purpose input/output or a user-programmable general purpose I/O. The main technology feature of the invention is that a pressing frequency or a pressing time generated by pressing the button 10 is used to generate a corresponding operation instruction to realize part of the operation functions of the keyboard. That is, the main body interface unit 11 may make the BIOS 12 execute the corresponding operation instruction according to the frequency or the time of pressing the button 10. The more detailed description is provided hereinbelow.

FIG. 2(a) is a schematic diagram showing the appearance of the computer device having an initialization setting function in a preferable embodiment of the invention. As shown in FIG. 2(a), a button 10 is additionally disposed at the front panel 2 of the main body case. A pressing frequency or a pressing time generated by pressing the button 10 is used to realize part of the functions of the keyboard. For example, when the main body is booted, a user presses the button 10 for the first time to enter the BIOS setting mode. After the BIOS setting mode is entered, pressing the button 10 once represents removing a cursor to the next option. Pressing the button 10 twice during a first preset time (such as one second) represents switching the current page to the next functional page. Pressing the button 10 for more than a second preset time (such as three seconds) represents confirming or modifying the value of the option. The combination of the frequency and the time of pressing the button is used to realize the conventional operation functions that is achieved by pressing the keyboard.

FIG. 2(b) is a schematic diagram showing the appearance of the computer device having an initialization setting function in another preferable embodiment of the invention. The appearance of the button is also shown in FIG. 2(b). In the embodiment, a cross-shaped button 20 is additionally disposed at the main body at the front panel 22 of the main body case, and part of the functions of the keyboard is realized by the cross-shaped button 20. For example, the upper button, the lower button, the left button and the right button of the cross-shaped button 20 are corresponding to the upper key, the lower key, the left key and the right key of the keyboard. Pressing the center of the cross-shaped button 20 represents confirming or modifying the value of the option.

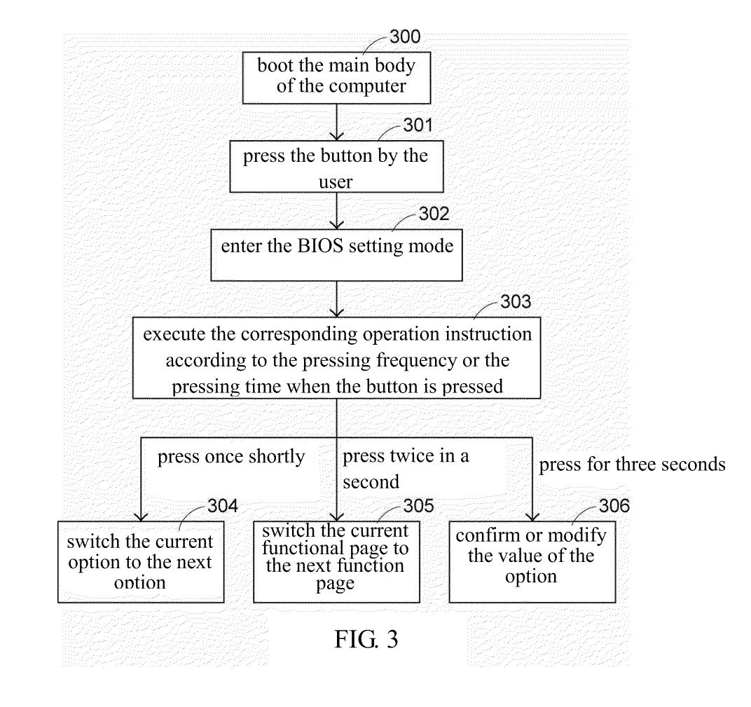

FIG. 3 is a flow chart showing the processing method for making an initialization setting for a computer in a preferable embodiment of the invention. As shown in FIG. 3, when the main body is booted (step 300), a user may press the button to check or to adjust the BIOS setting (step 301). When the button is pressed, the BIOS setting mode is entered (step 302). After the BIOS setting mode is entered, the main body interface unit makes the BIOS execute the corresponding operation instruction according to the pressing frequency or the pressing time generated when the button is pressed (step 303). For example, if the user presses the button once, the operation instruction is switching to the next option (step 304). If the user presses the button 10 twice during a first preset time (such as one second), the operation instruction is switching the current functional page to the next functional page (step 305). If the user presses the button 10 for more than a second preset time (such as three seconds), the operation instruction is confirming or modifying the value of the option (step 306).

To sum up, according to the computer device having the initialization setting function and the method for making an initialization setting for the computer provided in the invention, the main technology feature is that a button is additionally disposed at the main body at the front panel of the main body case. Thus, a user may press the button, and a pressing frequency or a pressing time is generated to make the BIOS execute the corresponding operation instruction. Thus, the problem that in the conventional computer the BIOS setting only can be adjusted by the keyboard and other external input devices is overcome.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer device having an initialization setting function, comprising:
a basic input/output system (BIOS);
a button generating a pressing frequency or a pressing time when it is pressed; and
a main body interface unit connected to the button and the BIOS, wherein the main body interface unit generates a corresponding operation instruction according to the pressing frequency or the pressing time and makes the BIOS execute the operation instruction.

2. The computer device having the initialization setting function according to claim 1, wherein the operation instruction is generated when the button is pressed once, and the operation instruction is switching to a next option.

3. The computer device having the initialization setting function according to claim 1, wherein the operation instruction is generated when the button is pressed twice during a first preset time, and the operation instruction is switching to a next functional page.

4. The computer device having the initialization setting function according to claim 1, wherein the operation instruction is generated when the button is pressed for more than a second preset time, and the operation instruction is confirming or modifying an option.

5. The computer device having the initialization setting function according to claim 1, wherein the main body interface unit is an embedded controller or a universal input/output chipset.

6. A method for making an initialization setting for a computer, comprising the steps of:
generating a pressing frequency or a pressing time using a button;
generating a corresponding operation instruction according to the pressing frequency or the pressing time; and
executing the operation instruction by a BIOS.

7. The method for initializing the computer according to claim 6, wherein the operation instruction is generated when the button is pressed once, and the operation instruction is switching to a next option.

8. The method for initializing the computer according to claim 6, wherein the operation instruction is generated when the button is pressed twice during a first preset time, and the operation instruction is switching to a next functional page.

9. The method for initializing the computer device according to claim 6, wherein the operation instruction is generated when the button is pressed for more than a second preset time, and the operation instruction is confirming or modifying an option.
